(19) United States
(12) Patent Application Publication
(10) Pub. No.: US 2009/0307019 A1
(43) Pub. Date: Dec. 10, 2009

(54) Method of Booking Hotel Reservations

(76) Inventor: Renato Grussu, New York, NY (US)

Correspondence Address: Nicholas P. Chiara, Esq.;HEDMAN & COSTIGAN, P.C., 1185 Avenue of the Americas, New York, NY, 10036-2601, US

(21) Appl. No.: 12/135,684

(22) Filed: Jun. 9, 2008

(51) Int. Cl. G06Q 10/00

(52) U.S. Cl. 705/5

(57) ABSTRACT

The present invention is a method for collecting same day hotel room availability based on unsold rooms or same day cancellations, and creating a database containing this information, wherein said database is then accessed over the internet by a website and searched by hotels, corporations or individuals looking to book a room on the same day.

### FIELD OF THE INVENTION

The present invention relates to the field of marketing reservations in the hospitality and other related industries via the internet. In particular, the present invention is a method of marketing, buying, selling and trading surplus and deficit inventory online. This includes hotel reservations as well as other reservations and inventory in the travel and hospitality industries, including, but not limited to, car rental, airline, theatre, restaurant and tours. Further, the present invention is a method of offering and selling hotel reservations beyond the hotels' cancellation deadline both between similarly related businesses, e.g. business to business, as well as among individuals and business, e.g. client to client and client to business.

### BACKGROUND OF THE INVENTION

Since the introduction of the internet, various methods and procedures have been developed to create new forms for booking hotel, travel and other related hospitality and entertainment industries online. However, an aspect of these related industries that have not benefited from advances resulting from the internet revolution is the “overbooking situation” which routinely occurs in all major urban and suburban hotels of all sizes and categories. Hotels and other related industries lose considerable revenue as a result of their inability to trade their surplus and deficit reservations.

Also, clients seeking to recover the loss of the deposit or payment of penalty, in whole or in part, resulting from hotel cancelation policies have no means at present available to recoup this amount by reselling their reservation to third parties; being either another hotel or individuals or business in need of “last minute” reservations for discount rooms. This holds true for other similarly situated purchasers of reservations.

There are currently three major methods by which hotels sell rooms online. First, hotels can sell blocks of reservations days, weeks, and months ahead of time to third parties that then list them online with travel websites such as EXPEDIA.COM; TRAVELOCITY.COM; PRICELINE.COM; or HOTELS.COM. Secondly, hotels can directly list their available reservations with the above referenced websites. A third option is for hotels to list and market their room availabilities on their own websites. Examples of such are HILTON.COM; MARRIOTT.COM; HOLIDAYINN.COM, etc.

At present, noone of these methods is of practical use to a hotel in an overbooking situation. Hotels attempt to predict how many reservations will convert into actual guests. Due to the inherent difficulty in accurately predicting the number of room cancelations, no shows, or changes in prearranged and reoccurring contracted guests counts, hotels regularly find themselves either overbooked, (a deficit of rooms to meet the number of actual guests) or with empty rooms (a surplus). Hotels anticipate a certain number of cancelations and no shows and as a matter of standard practice accept reservations in an amount greater than the number of available rooms in an effort to prevent empty rooms and the resulting loss in revenue. When hotels find themselves with a room deficit, they must “walk” a guest. Walking a guest is an industry term used to describe transferring a guest from an overbooked hotel to another hotel where there are available rooms. Additionally hotels must match the reservation by quantity, quality, location, price and category. This is often done at the expense of the hotel, causing the hotels considerable financial loss as well as damage to the reputation and good will of the hotel and its chain. This is also true for related business and industries that take and book reservations.

At present, hotels in an overbooking situation do not have access to “real time” information of availability of other nearby hotels that are undersold or had previously been fully booked, but now have availability due to cancellations; and visa versa. Hotels that need to “walk” their guests cannot utilize currently existing internet travel sites.

The methods used by hotels to sell rooms online described above are insufficient and ill-suited for hotels to resolve issues arising from their surplus or deficit of rooms for several reasons. First and most importantly, hotel online booking sites do not reflect “real-time” availability, since most of them are designed for attracting individuals seeking to book rooms days, weeks and months in advanced are not updated with sufficient regularity to be useful for other hotels. Online booking agents which pre-purchase allotments of unsold rooms are equally unhelpful to hotels which are overbooked since these sites tend to reflect room totals that have already accounted for this allotment whether it has been used or not.

It is standard practice in the hotel industry that unexpected same day inventory is managed by the front office management or by the overnight manager and not by the reservations department. Because it is standard practice for hotel reservations departments to be closed later in the day, the front office personnel are the ones responsible for walk-ins and overbooking situations, since these problems usually materialize later in the day or in the early evening. Additionally, it is standard practice for late night reservation requests to be directed to the hotel's front desk. Therefore, resolving problems associated with overbooking are left to the front desk to resolve on their own without benefit of the internet.

Since there is no internet option available to hotels to buy, sell or trade surplus rooms, they still operate by randomly calling other hotels to find out if they have availability and if they do, if their rates, amenities, location and other criteria, will meet their overbooked or walk-in guest's needs. This is not only an efficient means to accomplish this task; it is also not cost effective. It requires large amounts of manpower in both time and energy. Additionally it affects service and affects reputation. This method is unreliable and hotels do not always succeed in placing their guests in suitable rooms in other hotels, i.e. rooms of equal value, and must upgrade their guests at their own expense or transfer their guests to another market. This situation, which likewise occurs in related industries which offer reservations, is managed by similar means.

During high occupancy times of the year, such as holidays, high-season, and special local events such as conventions or trade shows, there is either extremely limited availability of rooms, or the market is assumed to be sold out. However, there are almost always, in fact many empty rooms. Presently, information as to the “real time” availability of rooms is very difficult to ascertain. Even in a technically slow period a hotel may find itself oversold and unable to find rooms to walk its guest to.

Additionally, hotels which experience unexpected last minute cancellations or no-shows; find it difficult to resell their unexpected inventory at the last moment. They may allot their rooms on their own web site, which does not provide extensive exposure, or they must hope to receive a phone call from guests or other hoteliers looking for same day rooms. Same day cancellations or no-shows are hard to rebook. It is only by chance or from calls received from other hotel's front desks seeking rooms that hotels are able to do so. Regularly, hotel rooms go unused even though there are potential guests in need of those very rooms. As well, the later in the evening it gets, the more difficult it becomes to orchestrate all the difficult logistics to walk a guest to anyone's satisfaction.

U.S. Pat. No. 7,069,228 describes an apparatus and method for internet based computer reservation booking systems. U.S. Pat. No. 7,069,228 describes the creation of websites for merchants with a built-in web-based reservation booking system. It further describes the on-line benefits of access, selection and immediacy in making real-time reservation/appointments over the Internet. It also describes a software product for a merchant's booking process by providing a central web-based reservation/appointment management system that can be used for all bookings, regardless if made by telephone, by a walk-in customer, or by a customer via the Internet.

The known methods of online booking of hotel reservations do not allow for the buying or selling of surplus rooms.

Therefore the need exists for an online method to assist in “walking” guests or filling same day cancellations.

### SUMMARY OF THE INVENTION

The present invention provides, in its principle embodiment, a novel method of finding and booking same day hotel reservations for last minute guest arrivals or overbooked guests.

It is another object of the present invention to provide a method of collecting same day hotel room cancellations and making them available to hoteliers and consumers.

It is another object of the present invention to provide a business to business website that allows a hotel to transfer guests to nearby hotels in overbooking or walk-in guest situations.

It is another object of the present invention to provide a business to business website that allows a hotel with last minute cancellations to inform other nearby hotels that it has available rooms.

It is another object of the present invention to provide a website and database that enables hotels to select other hotels and hospitality related properties on-line and book rooms, facilities and services in the desired establishment.

It is another object of the present invention to provide an apparatus that will allow hotels in an overbooking or walk-in situations to place their guests in other hotels that meet the desired features in terms of availability, rates, location, and rating.

It is another object of the present invention to provide a method for corporations with business accounts at hotels to sell their last minute cancellations.

It is another object of the invention to provide airlines with a method of finding rooms for passengers that due to last minute flight cancellations, need hotel accommodations.

It is another object of the present invention to provide a method for organizations to receive discounts when booking their stay at hotels and other establishments.

The present invention will give hotels with last minute availability a high visibility and will allow hotels in need of walking guests to know about that availability.

These and other objectives are met by the present invention which is a method for collecting same day hotel room availability based on unsold rooms, same day cancellations, or no shows and creating a database containing this information. Further, this database is then accessed and searched by hotels looking to fill same day reservations.

An additional embodiment of the present invention allows for corporations with business accounts at hotels to sell their last minute cancellations absorbing only reduced cancellation fees.

The present invention is not limited to the hospitality industry, and can be applied to other industries, including but not limited to, general travel, sales of cars, etc.

### DETAILED DESCRIPTION OF THE INVENTION

The present invention will allow hotels to have “real-time” access to other hotels' inventory. The invention will create a location where hotels can go to engage in the buying, selling and trading of each other's surplus and deficit rooms. Hotels will thus avoid injury to their reputations associated with “walking” their guests as well as saving them the high cost of securing new rooms for their guests when they are overbooked. In addition, this will allow hotels that have available inventory, often due to same day cancellations or no-shows, to re-sell their rooms and avoid subsequent loss of revenue. This invention will also benefit individuals looking to cancel their reservations, who would otherwise suffer loss due to cancelation penalties, and who at present have no avenue to recover their loss, a means to resell their reservation to a third party. This application is used for Business to Business (between hotels) and for client to third party and it is intended for but not limited to the Hospitality Business.

The present invention is a method of business and a software product that provides a two-way communication and instant booking between hotels and related establishments. The hotel that for various reasons finds itself in an overbooking situation due to inevitable miscalculations by their reservation department, errors in evaluating the no-show or cancellation factors, unexpected extended stays, etc. . . . , can connect to the internet and browse a website prepared according to the present invention for other hotels to which it can walk its guests. The present invention is expressly designed to search in “real-time” for rooms available in other hotels and for creating a location to establish an exchange for purchasing and selling surplus inventory.

The hotel that needs to walk its guests will be able to find another hotel which will meet the criteria required to host its guests. Such criterion includes, but is not limited to, location, rate, hotel rating, method of payment, room type, etc. . . . The website and database will search for a suitable hotel and will display the results. The software prepared according to the present invention will allow real-time booking of a reservation at the chosen property.

Additionally, the present invention allows hotels that have availability, or that were sold-out, but had same day cancellations or no-shows, to be able to re-sell their room inventory to other hotels at a discounted rate or a higher premium rate instantly.

The hotels with available rooms will upload their room availability to a database and display their information about the vacancy in terms of availability, number of rooms, services, rating, terms of payment, etc.

The present invention enables hotels to interact with each other, by finding the right property and relocate guests immediately, saving time, manpower, costs, and improving customer service.

In an overbooking situation hotels will be able, through a special internet-based application according to the present invention, to access a website to look up available rooms in the same city, and book their guests in those hotels. The present invention will allow the overbooked hotels to have easy access to inventory of other hotels and to choose the hotel that best fits their needs in terms of rates, location, rating, method of payment, and service.

The website can have pre-registration procedures and be password protected.

Further, hotels that have available rooms due to last minute cancellations, will be able to immediately re-sell their rooms, placing their rooms in the market for other hotels to buy at their best available rate.

The present invention can be extended to any other kind of business such as but not limited to, retail, wholesale, airlines, restaurants, etc. . . . The present invention is applicable to other industries such as, but not limited to, overbooked rental car agencies with customers needing cars and other rental car agencies that have available cars due to last minute cancellation or no shows; overbooked restaurants with customers needing tables and other restaurants with open tables due to last minute cancellation or no shows; overbooked theatre performances with customers needing seats and other theatre performances that have available seats due to last minute cancellation or no shows; and/or overbooked airlines with customers needing seats and other airlines servicing the same destinations with available seats due to last minute cancellation or no shows.

### BRIEF DESCRIPTION OF THE DRAWINGS

FIG. 1 is a flow chart describing the method an hotelier will use to access a website of the present invention to enable the hotelier to book a same day last minute reservation for a guest.

### DESCRIPTION OF THE PREFERRED EMBODIMENT

### EXAMPLE I

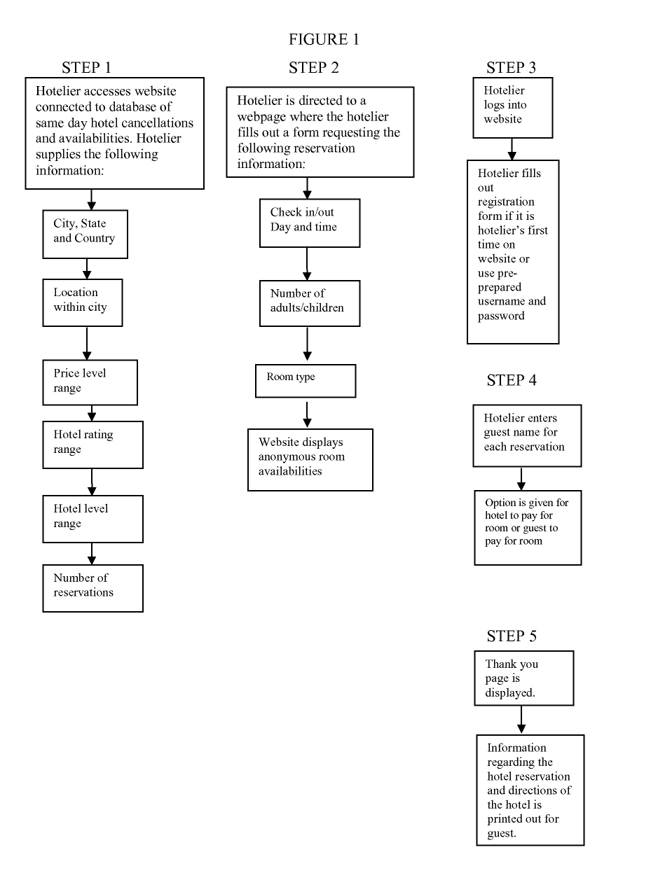

FIG. 1 describes the use of an interactive website according to the present invention. In the first step the hotelier accesses the website designed according to the present invention over the internet, and narrows his search results by selecting the relevant city, state and country, location within the city, price range, number of stars, hotel level, etc. . . . and chooses the number of reservations he would like to place. In the second step, the hotelier fills out the relevant reservation information according to the guest's needs and desires, such as check in/out day and time, number of occupant of each room, room type, etc. . . . Then, using the information from steps one and two above the website will access a database containing information and hotel room availability and inform the hotelier if there is availability for the requested reservation. At this point the hotelier does not know the specific hotel that has availability to reduce abuse of the system. In the third step the hotelier will log into the website using preprepared identification and passwords. If it is the hotelier's first time using the website, a form will appear asking the hotelier to fill out certain necessary information. Now the information about the identity of the hotel with availability is provided to the hoteiler and the reservations can either be confirmed or a new search can be performed. In step four, in order to complete the reservation the hoteleir needs to add the guest's name. At this point, the website will request payment method, which may be accomplished in one of two ways, either the overbooked hotelier can pay the hotel with vacancies directly and receive payment from the guest (or corporation sponsoring the guest) separately, or the guest can directly pay for the room.

Finally, step in step five, the hotelier will receive a thank you message and reservation information forms, including directions, to print and give the guest.

### EXAMPLE II

Hotels have varying reservation cancellation policies. Some allow cancelation by 6 pm the same day, others allow cancellations only 24 hours or more before check-in (most hotels), and still others only allow cancellations 48 hours, or more before check-in. If the reservation was not canceled according to the specific hotel cancellation policy, the guest (or the corporation paying for the business guest) must pay a cancellation penalty, which is typically the price of a one night-room rate plus taxes. This can amount to a significant expense especially when it comes to large corporations that pay such penalties in the multiples. Further, the currently available online travel websites, for example, EXPEDIA.COM and HOTELS.COM, have very strict cancellation policies.

The present invention allows clients (individuals and corporations) to post their rooms for sale in instances when they can no longer cancel the reservation per the hotel's cancellation policy, i.e., the hotel does not agree to waive their cancellation penalty. For example: Mr. X reserved a room at Hotel A and had to cancel the reservation after Hotel A's cancellation deadline. Hotel A has a 24 hour cancellation policy which has passed, and now Mr. X will need to pay a penalty (at least one night stay). However, using the website of the present invention, Mr. X can list his room for sale on a website according to the present invention. The website of the present invention will re-sell this last-minute room to another client (Mr. Y or Hotel Y) in need of a room in the same city, and who cannot find a room or is looking for a discounted rate. If the room is sold using the website of the present invention, Mr. X will receive a partial refund on the cancellation fee. Hotel A will get full payment for the room, and will simply have to change the name and credit card information for the specific reservation. Then Mr. X will get back a portion of the money, and Mr. Y will find a cheaper room and/or a room at the last minute in what originally appeared to be a fully booked city.

While certain preferred and alternative embodiments of the invention have been set forth for purposes of disclosing the invention, modifications to the disclosed embodiments may occur to those who are skilled in the art. Accordingly, the appended claims are intended to cover all embodiments of the invention and modifications thereof which do not depart from the spirit and scope of the invention.

We claim:

1. A method for collecting hotel room availability based on unsold rooms or same day cancellations, and creating a real time and constantly updated database containing this information, comprising the step of accessing said database and searching said database to book same day reservations over the internet on a website connected to said database.

2. The method according to claim 1, further comprising the step of selecting search parameters for the hotel reservation selected from the list including country, state, city, location within city, price level, hotel rating and hotel level.

3. The method according to claim 1, further comprising the step of directly booking said hotel room by a hotelier.

4. The method according to claim 3, further comprising the step of directly paying for the hotel room by the booking hotel.

5. The method according to claim 3, further comprising the step of directly paying for the room by the guest.

6. A website designed to access a database that stores information about same day room availability that is constantly updated in real time, and wherein said website can book an available room for a guest based on preselected search parameters.

7. The website according to claim 6, wherein the booking is done by a hotelier.

8. The website according to claim 6, wherein the search parameters for the hotel reservation are selected from the list including country, state, city, location within city, price level, hotel rating and hotel level.

9. The website according to claim 6, wherein a first customer has passed a cancellation deadline and said first customer lists a room in said database at full price or at a discounted price, and wherein if a second customer books the room for the cancelled day said first customer pays a discounted cancellation fee.

10. The website according to claim 9, wherein said discounted cancellation fee is zero if said second customer pays the full room price.

11. The website according to claim 9, wherein said discounted cancellation rate is lower then the full cancellation rate if said second customer pays said discounted price.

12. The method according to claim 1, comprising the following steps:
a) accessing said website over the internet,
b) narrowing search results based on hotel criteria,
c) searching a database using the information from steps (b) and (c) above, said,
d) providing information about the availability of the requested reservation,
e) logging into the website using identification and/or passwords,
f) Identifying the hotel with availability, and
g) confirming reservations or a performing a new search.

13. The method according to claim 12, wherein the information required in step (b) is selected from the group consisting of selected from the group consisting of relevant city, location, price range, number of stars, level and number of reservations.

14. The method according to claim 12, wherein the information required in step (c) is selected from the group consisting of guest name, number of guests, length of stay of guests, dietary requirements of guest, smoking preference of guest, and room type preference of guest.

15. The method according to claim 12, further comprising a step of directly paying for the room by the booking hotel.

16. The method according to claim 12, further comprising a step of directly paying for the hotel reservation by the guest.

17. The method according to claim 12, wherein all the nonautomated teps are performed by a hotelier.

18. The method according to claim 1, wherein a first customer has passed a cancellation deadline comprising:
a) listing a room in said database by said first customer at full price or at a discounted price, and
b) booking said room by a second customer for the cancelled day,
wherein said first customer pays a discounted cancellation fee.

19. The method according to claim 18, wherein said discounted cancellation fee is zero when said second customer pays full room price.

20. The method according to claim 18, wherein said discounted cancellation rate is lower then the full cancellation rate when said second customer pays said discounted price.
